(19) United States
(12) Patent Application Publication
(10) Pub. No.: US 2018/0376157 A1
(43) Pub. Date: Dec. 27, 2018

(54) IMAGE PROCESSING APPARATUS AND IMAGE PROCESSING METHOD

(71) Applicant: SOCIONEXT INC., Yokohama-shi (JP)

(72) Inventor: Tatsushi OTSUKA, Yokohama-shi (JP)

(21) Appl. No.: 16/119,609

(22) Filed: Aug. 31, 2018

Related U.S. Application Data
(63) Continuation of application No. PCT/JP2016/058878, filed on Mar. 18, 2016.

(51) Int. Cl. H04N 19/467; G06T 7/174

(52) U.S. Cl. CPC H04N 19/467; G06T 2207/10016; G06T 2207/20221; G06T 7/174

(57) ABSTRACT

An image processing apparatus receives input of an original image that is divided into at least two partial images in a top-and-bottom direction. The image processing apparatus adds a first line number of dummy screen lines to a top portion of a partial image that is a top portion of the original image. The image processing apparatus adds a second line number of dummy screen lines to a lower portion of a partial image that is a lower portion of the original image. The image processing apparatus uses a z×z encoding process unit and performs an encoding process for each of the partial images to which the dummy screen lines have been added.

### CROSS REFERENCE TO RELATED APPLICATIONS

This application is a continuation application of International Application PCT/JP2016/058878, filed on Mar. 18, 2016, and designating the U.S., the entire contents of which are incorporated herein by reference.

### FIELD

The embodiments discussed herein relate to an image processing apparatus and an image processing method.

### BACKGROUND

Images tend to recently have higher definition, and 4K2K (3,840×2,160) images, 8K4K (7,680×4,320) images, and the like may be photographed. According to one technique, 4K2K (3,840×2,160) images, 8K4K (7,680×4,320) images, and the like are each divided in a horizontal direction and the divided images are each assigned to any one of plural encoding processing apparatuses to execute encoding processes for the divided images.

For example, a technique is present as a related prior art according to which processing of each of pieces of divided video image data acquired by dividing the video image data into plural areas is executed being overlapped with the image processing in the image border face between a divided area and another divided area adjacent thereto. For example, according to another technique, each one of plural video image processing apparatuses constituting a multi-display system executes a statistic amount acquisition process for an area to be processed by the video image processing apparatus, together with and in parallel to another video image processing apparatus not executing any image input during the time period of the execution by the one apparatus. For example, according to another technique, image data including an optional number of pixels is converted into a block to be encoded using a single encoding method. For example, according to another technique, the number of pieces of data in one line in a filtering process and the number of pieces of data in one line that are scanned by quantizing and encoding are selectively switched between each other and a second-size image that is relatively small and whose use frequency is high is thereby encoded without being tile-divided. For examples, refer to International Publication No. WO 2009/147795, Japanese Laid-Open Patent Publication No. 2015-96920, Japanese Laid-Open Patent Publication No. H7-193809, and Japanese Laid-Open Patent Publication No. 2002-344747).

### SUMMARY

According to an aspect of an embodiment, an image processing apparatus includes a memory; and a processor coupled to the memory, the processor configured to: receive an input of an original image divided into at least two partial images in a top-and-bottom direction; for a top portion partial image of the original image whose input is received, add to a top portion of the top portion partial image, dummy screen lines of a first line number that is a difference of a number of effective screen lines included in the top portion partial image and an integral multiple of screen lines included in one encoding process unit of an encoding process, the integral multiple being greater than the number of effective screen lines included in the top portion partial image; for a bottom portion partial image of the original image whose input is received, add to a bottom portion of the bottom portion partial image, the dummy screen lines of a second line number that is a difference of the number of effective screen lines included in the bottom portion partial image and the integral multiple of screen lines included in the encoding process unit, the integral multiple being greater than the number of effective screen lines included in the bottom portion partial image; and for each of the partial images to which the dummy screen lines are added, execute the encoding process by using the encoding process unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of an EXAMPLE of an image processing method according to an embodiment;

FIG. 2 is an explanatory diagram of an example of an image processing system 200;

FIG. 3 is a block diagram of an example of a hardware configuration of an encoder apparatus 221;

FIG. 4 is a block diagram of an example of a hardware configuration of a main body unit 222;

FIG. 5 is a block diagram of an example of a functional configuration of an image processing apparatus 100;

FIG. 6 is an explanatory diagram of an example where the image processing apparatus 100 receives an input of an original image P;

FIG. 7 is an explanatory diagram of another example where the image processing apparatus 100 receives an input of the original image P;

FIG. 8 is an explanatory diagram of an example where the image processing apparatus 100 executes an encoding process;

FIG. 9 is an explanatory diagram of details for the encoder apparatus 221 to add dummy screen lines;

FIG. 10 is an explanatory diagram of details of an addition of a syntax 1000 by the image processing apparatus 100;

FIG. 11 is an explanatory diagram of an example where the image processing apparatus 100 synthesizes pieces of encoded data with each other;

FIG. 12 is a flowchart of an example of a procedure for the encoding process for a partial image at a head;

FIG. 13 is a flowchart of an example of a procedure for the encoding process for a partial image other than that at the head; and

FIG. 14 is a flowchart of an example of a procedure for a combining process.

### DESCRIPTION OF THE INVENTION

First, problems associated with the conventional techniques will be described. With the conventional techniques, it may be difficult to efficiently execute the encoding process for a photographed image. For example, when partial images are input that are acquired by dividing a photographed image into those on the right, left, top, and bottom thereof, the encoding process needs to be executed after reconstituting the partial images into partial images acquired by dividing the photographed image in the horizontal direction. Therefore, the encoding process may not be executed efficiently.

Embodiments of an image processing apparatus and image processing method according to the present invention will be described in detail with reference to the accompanying drawings.

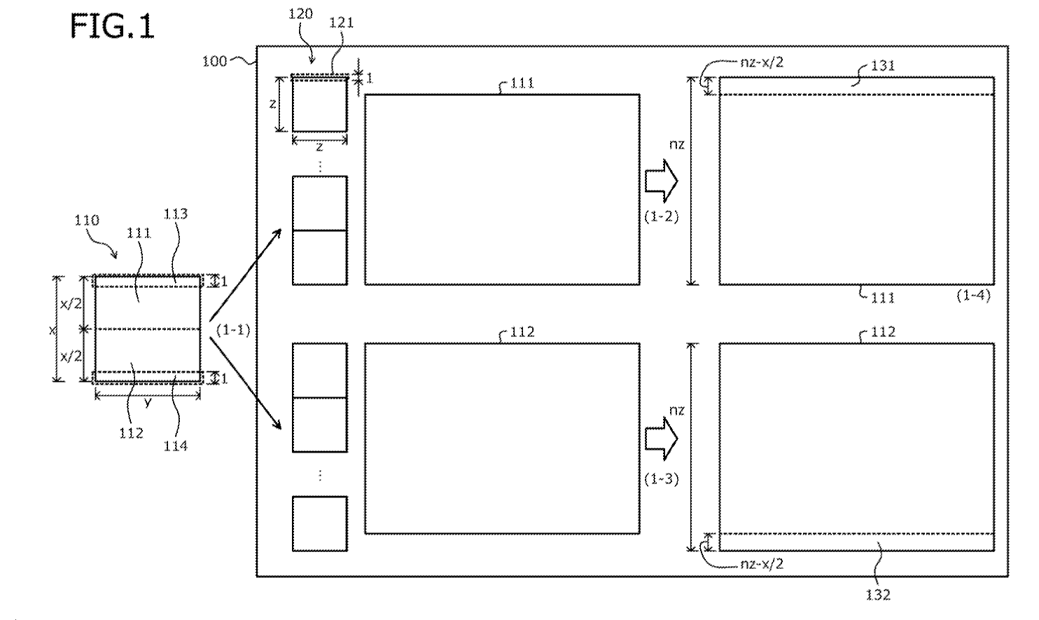

FIG. 1 is an explanatory diagram of an EXAMPLE of an image processing method according to the embodiment. An image processing apparatus 100 is a computer that executes an encoding process for an original image 110. The original image 110 is, for example, an 8K4K image. The “8K4K” represents that the resolution is 7,680×4,320. In the following description, “8K4K” may be written as “8K”.

Recently, images tend to have higher definition, and 8K images and the like may be photographed. It is therefore desirable to realize an encoding process and a decoding process for a photographed 8K image. As described in (a) to (c) below, it may however be difficult to realize the encoding process for the 8K image and to efficiently execute the encoding process for the 8K image.

(a) From a financial viewpoint and a viewpoint of market scale, it may not be preferable that a dedicated encoding processing apparatus executing the encoding process be manufactured to execute the encoding process for the 8K image. For example, from the financial viewpoint, it may not be preferable that a dedicated encoding processing apparatus that executes the encoding process for the 8K image and that is applied to a recording apparatus in a broadcast station be manufactured because the number of recording apparatuses and the like in broadcast stations is fewer than that of televisions and the like.

(b) In contrast, it is conceivable that the encoding processing apparatus diverts plural computing devices that each executes an encoding process for an image having a resolution lower than 8K, and causes the plural computing devices to share the encoding process for the 8K image to thereby realize the encoding process for the 8K image. For example, it is conceivable that an encoding process for each of four partial images acquired by dividing an 8K image into the four partial images is executed by any one of four computing apparatuses.

For example, it is conceivable that an 8K, that is, a 7,680×4,320 image is divided into three 7,680×1.088 partial images and one 7,680×1,056 partial image in accordance with an Association of Radio Industries and Business (ARIB) standard, and an encoding process for each of the partial images acquired by dividing the 8K image is executed by any one of four computing devices.

However, because it is difficult to transmit the photographed 8K Image as it is, this image tends to be divided in partial images each having a resolution lower than 8K to be transmitted and to be input into an encoding processing apparatus. For example, because no standard is present to transmit an 8K image as it is, the 8K image tends to be divided into four 4K2K partial images to be transmitted in accordance with a standard for transmitting 4K2K images. “4K2K” represents that the resolution is 3,840×2,160. In the following description, “4K2K” may be written as “4K”.

As described, the size tends to be different between the partial image for which the encoding process is executed and the transmitted partial image. The encoding processing apparatus therefore has to reconstitute the three 7,680×1,088 partial images and the one 7,680×1,056 partial image that support the ARIB standard from four 4K partial images after receiving the input of the four 4K partial images that are acquired by dividing an 8K image.

As a result, the encoding processing apparatus has a reconstituting circuit disposed therein that reconstitutes the three 7,680×1,088 partial images and the one 7,680×1,056 partial image that support the ARIB standard, from the four 4K partial images. This may not be preferable from the financial viewpoint and due to the load applied at the time of the introduction thereof. As to the reconstituting circuit, the scale of the circuit becomes larger as the partial images whose input is received each become larger. This may not be preferable from the financial viewpoint. The four computing devices share the processing after the encoding processing apparatus reconstitutes the three 7,680×1,088 partial images and the one 7,680×1,056 partial image, and the time period necessary for the reconstitution is increased as the partial images each become larger. It is therefore likely that the encoding process cannot be efficiently executed.

The case can further be considered where a display system displays an 8K image. In this case, the display system tends to divide the 8K image into four 4K partial images to display the 8K image. On the other hand, the display system has to receive the three 7,680×1,088 partial images and the one 7,680×1,056 partial image to which the encoding process is applied, and therefore has to decode the three 7,680×1,088 partial images and the one 7,680×1,056 partial image to acquire these partial images.

As described, the size tends differ for the partial image decoded by the display system and the partial image displayed by the display system. The display system, therefore, has to reconstitute the four 4K partial images from the three 7,680×1,088 partial images and the one 7,680×1,056 partial image after decoding the three 7,680×1,088 partial images and the one 7,680×1,056 partial image.

As a result, the display system also has a reconstituting circuit disposed therein that reconstitutes the four 4K partial images from the three 7,680×1,088 partial images and the one 7,680×1,056 partial image. This may not be preferable from the financial viewpoint and due to the load applied at the time of the introduction thereof. The display system has to reconstitute the four 4K partial images and thereafter display the reconstituted image as an 8K image. The time period necessary for the reconstitution increases as the partial images each becomes larger. It is possible that the 8K image may not be efficiently displayed.

(c) For example, it is conceivable that an 8K image is divided into four 4K partial images using a dividing method called “TILE division” and encoding processes for the four 4K partial images are executed by four computing devices. The TILE division is defined in, for example, a High Efficiency Video Coding (HEVC) standard. A standard other than the HEVC standard may be employed only when the TILE division is executable in accordance therewith.

The 4K partial images for which the four computing devices execute the encoding processes are combined with each other and the combined image is output as an 8K image for which the encoding process is executed. According to this, the encoding processing apparatus may cause each of the four computing devices to process any one of the partial images as they are after receiving the input of the four 4K partial images acquired by dividing the 8K image.

The encoding process may be executed using, for example, any one of a 16×16 encoding process unit, a 32×32 encoding process unit, and a 64×64 encoding process unit, each called “Coding Tree Unit (CTU)”. The encoding process tends to be executed more efficiently as the encoding process unit becomes larger. Therefore, it tends to be desirable for the encoding process to be executed using a relatively large encoding process unit.

An encoding process for a 4K partial image acquired by executing the TILE division for an 8K image has to be executed using the 16×16 encoding process unit because the 4K (3,840×2,160) partial image is not divisible by the 32×32 encoding process unit and the 64×64 encoding process unit. As a result, it is difficult to efficiently execute the encoding process for the 4K partial images.

In this embodiment, an image processing method will be described with which the encoding process may be executed efficiently for the original image 110 that is divided into at least two in a top-and-bottom direction. The original image 110 is the target for which the encoding process is executed. In the example of FIG. 1, the original image 110 is a y×x image. “y×x” represents that the number of pixels in the transverse direction is y and the number of pixels in the longitudinal direction is x.

(1-1) The image processing apparatus 100 receives input of the original image 110 that is divided into at least two in the top-and-bottom direction. The “top” of the original image 110 refers to the side on which a line is present for which the encoding process is first executed in accordance with the encoding order, of plural lines in the encoding direction of the original image 110. The “bottom” of the original image 110 refers to the side on which a line is present for which the encoding process is later executed in accordance with the encoding order, of the plural lines in the encoding direction of the original image 110.

In the example of FIG. 1, a photographic equipment such as a camera photographs the y×x original image 110, divides the photographed original image 110 into two in the top-and-bottom direction, and transmits each of two y×x/2 partial images 111 and 112 acquired by dividing the original image 110, to the image processing apparatus 100.

On the other hand, the image processing apparatus 100 receives each of the two y×x/2 partial images 111 and 112 acquired by dividing the y×x original image 110, from the camera. In this case, each of the y×x/2 partial images 111 and 112 acquired by dividing the y×x original image 110 into at least two in the top-and-bottom direction may not be divisible by a predetermined encoding process unit 120. For example, when x/2 is not a multiple of 64, the y×x/2 partial images 111 and 112 are each not divisible by the 64×64 encoding process unit 120.

(1-2) For the top portion partial image 111 of the original image 110 whose input is received, the image processing apparatus 100 adds a first line number of dummy screen lines 131 to the top portion of the partial image 111. The first line number is the difference of the number of the effective screen lines included in the top portion partial image 111 and an integral multiple of the number of the screen lines included in the one encoding process unit 120 of the encoding process. The “dummy screen line” is a line having a width that corresponds to one pixel, along the encoding direction of the top portion partial image 111, to be added to the top portion partial image 111.

The “effective screen line included in the top portion partial image 111” is a line having a width that corresponds to one pixel, along the encoding direction of the top portion partial image 111. In the example of FIG. 1, the effective screen lines included in the top portion partial image 111 are each a y×1 line 113 along the encoding direction and the like, of the top portion partial image 111, and x/2 lines thereof are present. The screen lines included in the encoding process unit 120 are each a line having a width that corresponds to one pixel along the encoding direction, of the encoding process unit 120. In the example of FIG. 1, the screen lines included in the encoding process unit 120 are each, for example, a z×1 line 121 and the like, along the encoding direction, of the z×z encoding process unit 120, and z lines thereof are present.

In the example of FIG. 1, assuming that the integral multiple of the number of the screen lines included in the encoding process unit 120 is nz, the first line number therefore is nz−x/2. In other words, the first line number represents how many lines need to be added to the number of effective screen lines included in the top portion partial image 111 to establish a multiple of the screen lines included in the encoding process unit 120.

In the example of FIG. 1, the image processing apparatus 100 adds nz−x/2 dummy screen lines 131 to the top portion of the top portion partial image 111, of the original image 110 whose input is received. The image processing apparatus 100 may thereby cause the total of the number of the effective screen lines included in the top portion partial image 111 after the nx−x/2 dummy screen lines 131 are added thereto and the number of the dummy screen lines, to be the multiple of the number of the screen lines included in the encoding process unit 120.

(1-3) For the bottom portion partial image 112 of the original image 110 whose input is received, the image processing apparatus 100 adds a second line number of dummy screen lines 132 to the bottom portion of the partial image 112. The second line number is the difference of the number of the effective screen lines included in the bottom portion partial image 112 and an integral multiple of the number of the screen lines included in the one encoding process unit 120 of the encoding process. The “dummy screen line” refers to a line having a width that corresponds to one pixel, along the encoding direction in the bottom portion partial image 112 to be added to the bottom portion partial image 112.

The “effective screen lines included in the bottom portion partial image 112” each refers to a line having a width that corresponds to one pixel, along the encoding direction of the bottom portion partial image 112. In the example of FIG. 1, the effective screen lines included in the bottom portion partial image 112 are y×1 lines 114 and the like, along the encoding direction, of the y×x/2 partial image of the bottom portion, and x/2 lines thereof are present.

In the example of FIG. 1, the second line number is therefore nx−x/2 assuming that the integral multiple of the number of the screen lines included in the encoding process unit 120 is nz. In other words, the second line number represents how many lines need to be added to the number of effective screen lines included in the bottom portion partial image 112 to establish a multiple of the number of the screen lines included in the encoding process unit 120.

In the example of FIG. 1, the image processing apparatus 100 adds nz−x/2 dummy screen lines 132 to the bottom portion of the bottom portion partial image 112, of the original image 110 whose input is received. The image processing apparatus 100 may thereby cause the total of the number of the effective screen lines included in the bottom portion partial image 112 after the nx−x/2 dummy screen lines 132 are added thereto and the number of the dummy screen lines to be a multiple of the number of the screen lines included in the encoding process unit 120.

(1-4) The image processing apparatus 100 executes the encoding process for each of the partial images 111 and 112 each having the dummy screen lines added thereto, using the z×z encoding process unit 120. For example, the image processing apparatus 100 executes the encoding process for the top portion partial image 111 acquired after the addition of the nx−x/2 dummy screen lines 131 thereto, using the z×z encoding process unit 120. The image processing apparatus 100 executes the encoding process for the bottom portion partial image 112 acquired after the addition of the nx−x/2 dummy screen lines 132 thereto, using the z×z encoding process unit 120.

The image processing apparatus 100 may thereby execute the encoding process after causing the partial images that are the targets of the encoding process to be divisible by the encoding process unit 120 by adding the dummy screen lines thereto. The image processing apparatus 100 may thereby execute the encoding process even when the encoding process unit 120 is increased, and may efficiently execute the encoding process.

For example, the image processing apparatus 100 may utilize the 32×32 and the 64×64 encoding process units 120 with which the encoding process may be executed efficiently using plural encoding processing apparatuses that support 4K even without any 8K-dedicated encoding processing apparatus. In this case, the image processing apparatus 100 does not need to recombine the plural partial images received from a photographic equipment such as a camera with each other to produce new partial images to be the targets of the encoding process, and does not need to use a new circuit to recombine the plural partial images with each other. From the above, the image processing apparatus 100 may enable the encoding process by enlarging the encoding process unit 120 even without use of a new circuit, and may efficiently execute the encoding process.

While a case where the original image 110 is divided into at least two in the top-and-bottom direction has been described, the division is not limited hereto. For example, the original image 110 may be divided into two in the top-and-bottom direction and may further be divided into two or more in the right-and-left direction. The “left” of the original image 110 refers to the side on which the pixel is present for which the encoding process is first executed in accordance with the encoding order, of any line in the encoding direction of the original image 110. The “left” of the original image 110 refers to the side on which the pixel is present for which the encoding process is later executed in accordance with the encoding order, of any line in the encoding direction of the original image 110.

While a case where the original image 110 is divided into two in the top-and-bottom direction and where the size in the direction perpendicular to the encoding direction of each of the partial images acquired by dividing the original image 110 into two in the top-and-bottom direction is not divisible by the 64×64 encoding process unit 120 or the like has been described, the division is not limited hereto. For example, a case may be employed where the original image 110 is divided into two in the right-and-left direction and where the size in the encoding direction of each of the partial images acquired by dividing the original image 110 into two in the right-and-left direction is not divisible by the 64×64 encoding process unit 120 or the like.

In this case, the image processing apparatus 100 adds a dummy screen sequence along the direction perpendicular to the encoding direction to the left portion of the left portion partial image or the right portion of the right portion partial image, of the partial images acquired by dividing the original image 110 into two in the right-and-left direction. The image processing apparatus 100 may thereby efficiently execute the encoding process. In this case, the original image 110 may further be divided into two in the top-and-bottom direction.

For example, a case may be employed where the original image 110 is divided into two in the top-and-bottom direction and further into two in the right-and-left direction and where the size in the encoding direction and the size in the direction perpendicular to the encoding direction of each of the partial images acquired by dividing the original image 110 are not divisible by the encoding process unit 120.

In this case, the image processing apparatus 100 adds the dummy screen lines along the encoding direction to the top portion of the upper-left portion partial image and adds the dummy screen sequence along the direction perpendicular to the encoding direction to the left portion of the upper-left portion partial image, of the partial images acquired by dividing the original image 110. Similarly, the image processing apparatus 100 adds the dummy screen lines along the encoding direction to the top portion of the upper-right portion partial image and adds a dummy screen sequence along the direction perpendicular to the encoding direction to the right portion of the upper-right portion partial image, of the partial images acquired by dividing the original image 110.

Similarly, the image processing apparatus 100 adds the dummy screen lines along the encoding direction to the bottom portion of the lower-left portion partial image and adds a dummy screen sequence along the direction perpendicular to the encoding direction to the left portion of the lower-left portion partial image, of the partial images acquired by dividing the original image 110. Similarly, the image processing apparatus 100 adds the dummy screen lined along the encoding direction to the bottom portion of the lower-right portion partial image and adds a dummy screen sequence along the direction perpendicular to the encoding direction to the right portion of the lower-right portion partial image, of the partial images acquired by dividing the original image 110. The image processing apparatus 100 may thereby efficiently execute the encoding process.

While a case where the original image 110 is the y×x image has been described, the original image is not limited hereto. For example, the original image 110 is an 8K (7,680×4,320) image. For example, the original image 110 may have the resolution of 8K or higher and may be a 16K8K (15,360×8,640) image. While a case where the encoding process unit 120 is has a square shape has been described, the shape of the unit is not limited hereto. For example, the encoding process unit 120 may have a rectangular shape.

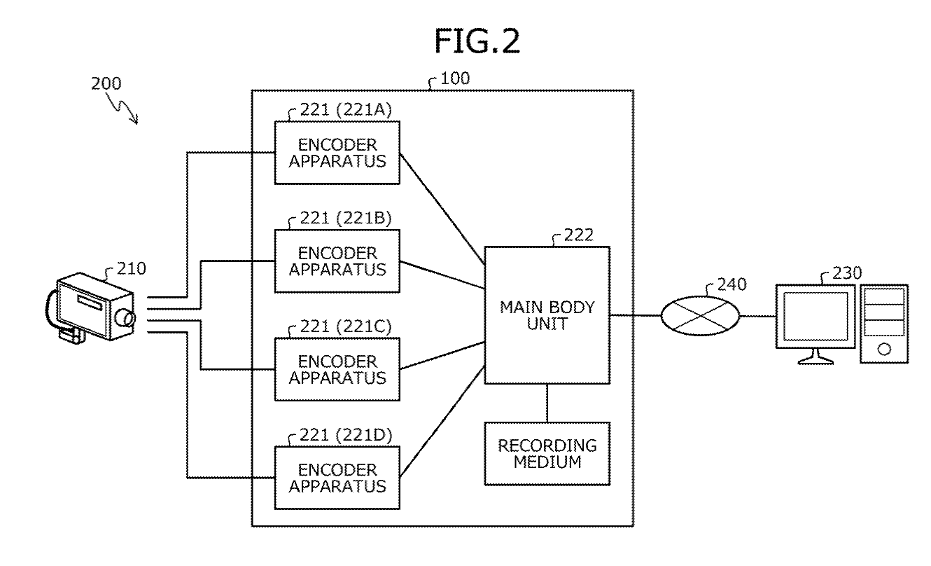

An example of an image processing system 200 to which the image processing apparatus 100 depicted in FIG. 1 is applied will be described with reference to FIG. 2.

FIG. 2 is an explanatory diagram of an example of the image processing system 200. In FIG. 2, the image processing system 200 includes photographic equipment 210, an image processing apparatus 100, and a decoding processing apparatus 230. In the image processing system 200, the image processing apparatus 100 and the decoding processing apparatus 230 may be connected to each other through a wired or a radio network 240. Alternatively, images may be recorded as data in a recording medium in the image processing apparatus 100, and the recording medium may be taken out to be connected to the decoding processing apparatus 230 to extract the data. The network 240 is, for example, a local area network (LAN), a wide area network (WAN), the Internet, or the like.

The photographic equipment 210 is an apparatus that photographs the original image and that transmits the photographed original image to the image processing apparatus 100. For example, the photographic equipment 210 photographs an 8K original image and transmits partial images acquired by dividing the photographed 8K original image into four to encoder apparatuses 221 included in the image processing apparatus 100 through dedicated lines. The photographic equipment 210 is, for example, a camera.

The image processing apparatus 100 is a computer that executes the encoding process for the original image. For example, the image processing apparatus 100 receives the partial images acquired by dividing the 8K original image into four, adds the dummy screen lines to each of the partial images, and thereafter executes the encoding process. The image processing apparatus 100 includes the plural encoder apparatuses 221 and a main body unit 222. In the example of FIG. 2, the four encoder apparatuses 221 are present. The encoder apparatuses are each, for example, a board and are each inserted into a slot of the image processing apparatus 100. In the following description, when the encoder apparatuses 221 are distinguished from each other, the encoder apparatuses 221 may be written as the encoder apparatus 221A, the encoder apparatus 221B, the encoder apparatus 221C, and the encoder apparatus 221D. The image processing apparatus 100 is, for example, a recording apparatus in a broadcast station.

The decoding processing apparatus 230 is a computer that receives the 8K image for which the encoding process is executed, that executes the decoding process for the 8K image for which the encoding process is executed, and that displays the 8K image. The decoding processing apparatus 230 is, for example, a television, an outdoor display, digital signage, or the like. While a case where the image processing apparatus 100 includes the four encoder apparatuses 221 has been described, the number of the encoder apparatuses 221 is not limited hereto. For example, the image processing apparatus 100 may include the two encoder apparatuses 221.

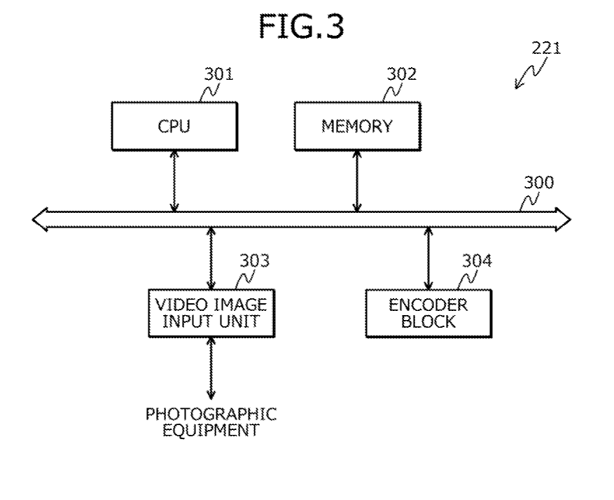

An example of the hardware configuration of the encoder apparatus 221 will be described with reference to FIG. 3.

FIG. 3 is a block diagram of an example of the hardware configuration of the encoder apparatus 221. In FIG. 3, the encoder apparatus 221 includes a central processing unit (CPU) 301, a memory 302, a video image input unit 303, and an encoder block 304. These components are connected to each other by a bus 300.

The CPU 301 supervises the control of the encoder apparatus 221 overall. The memory 302 includes, for example, a read only memory (ROM), a random access memory (RAM), a flash ROM, and the like. For example, the flash ROM and the ROM store various types of programs therein and the RAM is used as the work area for the CPU 301. The programs stored in the memory 302 are loaded onto the CPU 301 and thereby cause the CPU 301 to execute processes coded in the programs. The memory 302 may further include one or more frame memory/memories. The frame memory is a dedicated storage area that has one image stored therein.

The video image input unit 303 is connected to the photographic equipment 210 through a dedicated line. For example, the video image input unit 303 is connected to the photographic equipment 210 through plural dedicated lines. For example, the video image input unit 303 is connected to the photographic equipment 210 using four HDMI cables in accordance with a transmission standard called High-Definition Multimedia Interface (HDMI)-2.0. “HDMI” is a registered tradename. For example, the video image input unit 303 may be connected to the photographic equipment 210 using 16 coaxial cables in accordance with a transmission standard called 3G-Serial Digital Interface (SDI). Instead of 3G-SDI, the video image input unit 303 may use each of transmission standards called 6G-SDI and 12G-SDI. The video image input unit 303 supervises an internal interface the photographic equipment 210 to control the input from the photographic equipment 210 of each of the partial images acquired by dividing the original image. The encoder block 304 is a circuit capable of executing the encoding process for a moving image such as HEVC.

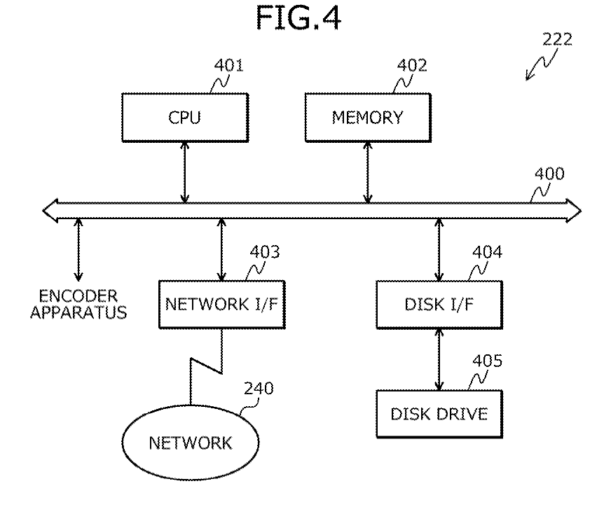

An example of hardware configuration of the main body unit 222 will be described with reference to FIG. 4.

FIG. 4 is a block diagram of an example of a hardware configuration of the main body unit 222. In FIG. 4, the main body unit 222 includes a CPU 401, a memory 402, a network I/F 403, a device I/F 404, and a disk drive 405. These components are connected to each other by a bus 400.

The CPU 401 supervises control of the main body unit 222 overall. The memory 402 includes, for example, a ROM, a RAM, and a flash ROM, or the like. In particular, for example, the flash ROM and ROM store various types of programs therein and the RAM is used as a work area of the CPU 401. Programs stored in the memory 402 are loaded onto the CPU 401 and thereby cause the CPU 401 to execute processes coded in the programs.

The network I/F 403 is connected to the network 240 through a communications line and is connected to other computers (e.g., the decoding processing apparatus 230 depicted in FIG. 2) via the network 240. The network I/F 403 supervises an internal interface with the network 240 and controls the input and output of data from the other computers. For example, a modem, a LAN adapter, etc. may be adopted as the network I/F 403.

The device I/F 404, under the control of the CPU 401, controls the reading and writing of data with respect to the disk drive 405. The disk drive 405, for example, is a magnetic disk. The disk drive 405 is a non-volatile storage medium that stores data written thereto under the control of the device I/F 404. The disk drive 405 includes, for example, a magnetic disk, an optical disk, a solid state drive (SSD), etc.

The bus 400 is further connected to the plural encoder apparatuses 221. The bus 400 is used for inputting and outputting between the components and the encoder apparatuses 221, and enables inputting of the encoded data acquired by executing the encoding process by the encoder apparatuses 221 for the partial images, into the components.

In addition to the above components, the main body unit 222 may include, for example, a semiconductor memory, a keyboard, a mouse, and a display.

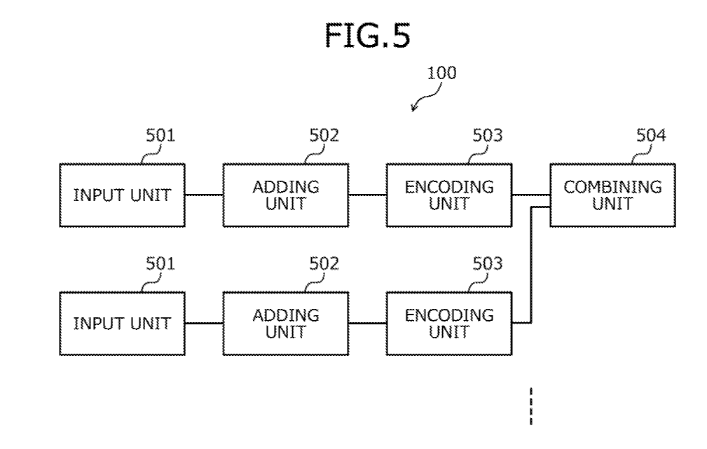

An example of a functional configuration of the image processing apparatus 100 will be described with reference to FIG. 5.

FIG. 5 is a block diagram of an example of the functional configuration of the image processing apparatus 100. The image processing apparatus 100 includes an input unit 501, an adding unit 502, an encoding unit 503, and a combining unit 504.

The components from the input unit 501 to the encoding unit 503 are functions constituting a control unit and functions thereof are realized, for example, by causing the CPU 301 to execute the programs stored in the memory 302 depicted in FIG. 3, or by the video image input unit 303. The processing results of the components from the input unit 501 to the encoding unit 503 are stored to, for example, the memory 302.

The combining unit 504 is a function constituting the control unit and the function is realized by, for example, causing the CPU 401 to execute the programs stored in a storage area such as that memory 402 or the disk drive 405 depicted in FIG. 4, or by the network I/F 403. The processing results of the combining unit 504 are stored to, for example, the storage area such as the memory 402 or the disk drive 405.

The input unit 501 receives an input of the original image that is divided into at least two in the top-and-bottom direction. The original image is a target for which the encoding process is executed. The original image is, for example, an 8K image. The original image is, for example, each of images included in an 8K video image. For example, the input unit 501 receives an input of the original image that is each of plural original images included in the photographed video image and that is divided into at least two in the top-and-bottom direction.

For example, it is conceivable in this case that the photographic equipment 210 photographs an 8K original image and transmits to the image processing apparatus 100 two 7,680×2,160 images acquired by dividing the 8K original image into at least two in the top-and-bottom direction. On the other hand, for example, the input unit 501 receives from the photographic equipment 210, the two 7,680×2,160 images acquired by dividing the 8K original image into two in the top-and-bottom direction. The input unit 501 may thereby input the original image to be the target of the encoding process.

The input unit 501 may receive an input of the original image 110 that is divided into two in the top-and-bottom direction and further into two in the right-and-left direction. For example, the input unit 501 receives an input of the original image that is divided into two in the top-and-bottom direction and further into two in the right-and-left direction and that is each of plural original images included in the video image.

For example, it is conceivable that the photographic equipment 210 photographs the 8K original image and transmits to the image processing apparatus 100, the four 4K partial images acquired by dividing the 8K original image into two in the top-and-bottom direction and further into two in the right-and-left direction. On the other hand, for example, the input unit 501 receives from the photographic equipment 210, the four 4K partial images acquired by dividing the 8K original image into two in the top-and-bottom direction and further into two in the right-and-left direction. The input unit 501 may input the original image to be the target of the encoding process.

For the top portion partial image of the original image whose input is received by the input unit 501, the adding unit 502 adds the first line number of dummy screen lines to the top portion of the partial image. The “first line number” is the difference of the number of the effective screen lines included in the top portion partial image and an integral multiple of the number of the screen lines included in one encoding process unit of the encoding process. The “dummy screen lines” are each a line having a width that corresponds to one pixel, along the encoding direction of the top portion or the bottom portion partial image, to be added to the top portion or the bottom portion partial image. The “effective screen lines included in the top portion partial image” are each a line having a width that corresponds to one pixel, along the encoding direction of the top portion partial image. The “screen lines included in the encoding process unit” are each a line having a width that corresponds to one pixel, along the encoding direction, of the encoding process unit.

For example, in a case where the number of the effective screen lines included in the top portion partial image is 2,160 and the number of the screen lines included in the encoding process unit is 32 or 64, the adding unit 502 adds 16 dummy screen lines to the top portion of the top portion partial image. For example, the adding unit 502 adds the 16 dummy screen lines to the top portion of the top portion 4K (3,840×2,160) partial image and thereby, produces the top portion 3,840×2,176 partial image acquired after the addition of the dummy screen lines.

The adding unit 502 may thereby produce the top portion 3,840×2,176 partial image for this partial image to be divisible by a 32×32 encoding process unit or a 64×46 encoding process unit, and may efficiently execute the encoding process.

For the bottom portion partial image of the original image whose input is received by the input unit 501, the adding unit 502 adds the second line number of dummy screen lines to the bottom portion of the partial image. The “second line number” is a number that is the difference of the number of the effective screen lines included in the bottom portion partial image and an integral multiple of the number of the screen lines included in one encoding process unit of the encoding process, and that is greater than the number of the effective screen lines included in the partial image. The “effective screen lines included in the bottom portion partial image” is each a line having a width that corresponds to one pixel, along the encoding direction of the bottom portion partial image.

For example, for a case where the number of the effective screen lines included in the bottom portion partial image is 2,160 and the number of the screen lines included in the encoding process unit is 32 or 64, the adding unit 502 adds 16 dummy screen lines to the top portion of the bottom portion partial image. For example, the adding unit 502 adds the 16 dummy screen lines to the bottom portion of the bottom portion 4K (3,840×2,160) partial image and thereby, produces the bottom portion 3,840×2,176 partial image acquired after the addition of the dummy screen lines.

The adding unit 502 may thereby produce the bottom portion 3,840×2,176 partial image for this partial image to be divisible by a 32×32 encoding process unit or a 64×46 encoding process unit, and may efficiently execute the encoding process.

The encoding unit 503 executes the encoding process using the encoding process unit, for each of the partial images each having the dummy screen lines added thereto. For example, the encoding unit 503 executes the encoding process using the 32×32 encoding process unit or the 64×46 encoding process unit, for each of the partial images each having the dummy screen lines added thereto.

For example, the encoding unit 503 executes the encoding process using the 32×32 encoding process unit or the 64×46 encoding process unit, for the top portion 3,840×2,176 partial image after the addition of the dummy screen lines. The image processing apparatus 100 executes the encoding process using the 32×32 encoding process unit or the 64×46 encoding process unit, for the bottom portion 3,840×2.176 partial image after the addition of the dummy screen lines. The encoding unit 503 may thereby efficiently execute the encoding process.

The combining unit 504 combines bit streams that each corresponds to the partial image produced by the execution of the encoding process by the encoding unit 503, with each other according to a predetermined order to produce a bit stream that corresponds to the original image. The “predetermined order” is, for example, an order of the upper-left partial image, the upper-right partial image, the lower-left partial image, and the lower-right partial image, of the original image. The combining unit 504 may assemble each of the partial images for which the encoding process is executed, for each of the original images.

The combining unit 504 outputs the first line number and the second line number correlated with the original images for which the encoding process is executed. For example, the encoding unit 503 or the combining unit 504 outputs the original image for which the encoding process is executed, correlating the original image with the first line number and the second line number as a syntax. The original image having the dummy screen lines removed therefrom may thereby be decoded from the original image when the decoding process is executed therefor.

The combining unit 504 combines the original images for which the encoding process is executed with each other according to the display order of the original images in the video image. The combining unit 504 may thereby produce the video image for which the encoding process is executed, and may store the video image for which the encoding process is executed to the memory 402, the disk drive 405, or the like, or may transmit the video image for which the encoding process is executed to the decoding processing apparatus 230.

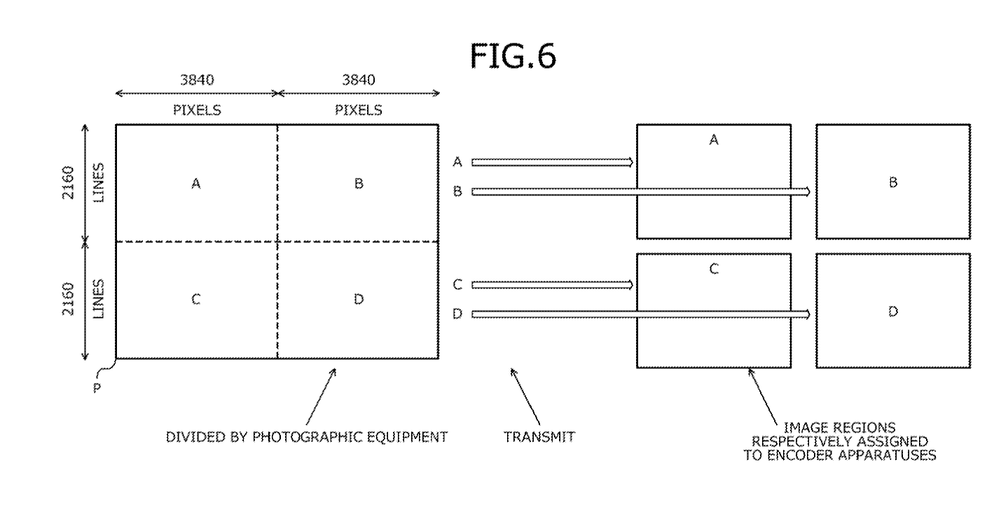

An example of a flow of operations of the image processing apparatus 100 will be described with reference to FIGS. 6 to 10.

FIG. 6 is an explanatory diagram of an example where the image processing apparatus 100 receives an input of the original image P. In FIG. 6, the photographic equipment 210 photographs an 8K video image and divides each of n 8K original images P included in the 8K video image into two in the top-and-bottom direction and further into two in the right-and-left direction to produce four 4K partial images A to D.

In the following description, when an original image P is distinguished to clarify that how many original images P are present before and including this original image P of the video image, the original image P may be written as “original image P(i)”. “i” is a value that represents how many original images P are present before and including this original image P. “i” is one to n. In the following description, when the partial images A to D are distinguished to clarify that how many original images P are present before and including the original image P that is divided to produce these partial images A to D of the n original images P, the partial images A to D may be written as “partial images A(i) to D(i)”.

For each of the 8K original image P, of the produced four 4K partial images A to D, the photographic equipment 210 transmits the 4K partial image to be processed by any one of the encoder apparatuses 221A to 221D, to the one of the encoder apparatuses 221A to 221D through the dedicated line. Each of the encoder apparatuses 221A to 221D has an area assigned thereto of the original image P set therefor, and is assigned to the partial image that corresponds to the area assigned thereto. For example, the photographic equipment 210 transmits each of the 4K partial images A to D using an HDMI cable connected to any one of the encoder apparatuses 221A to 221D in accordance with the transmission standard called HDMI-2.0.

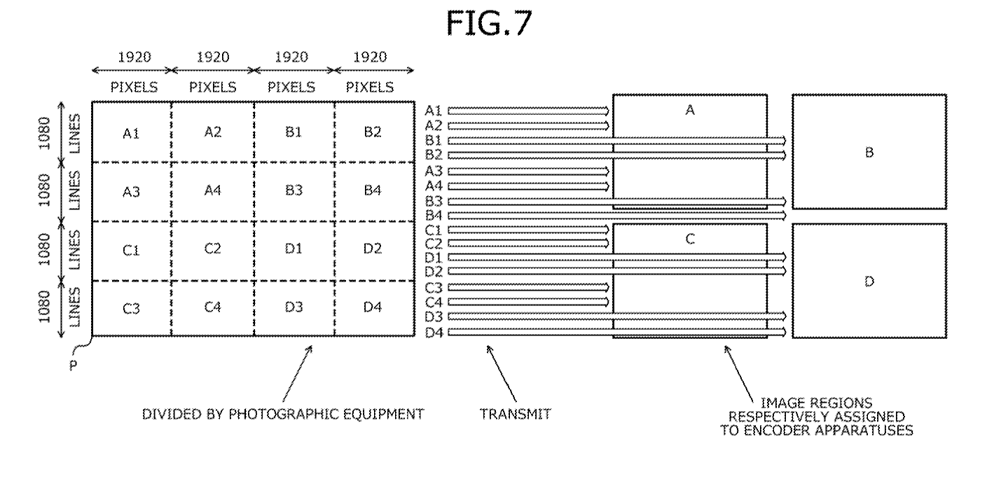

The encoder apparatus 221A receives the 4K partial image A to be processed by the encoder apparatus 221A from the photographic equipment 210 through the dedicated line. The encoder apparatus 221B receives the 4K partial image B to be processed by the encoder apparatus 221B from the photographic equipment 210 through the dedicated line. The encoder apparatus 221C receives the 4K partial image C to be processed by the encoder apparatus 221C from the photographic equipment 210 through the dedicated line. The encoder apparatus 221D receives the 4K partial image D to be processed by the encoder apparatus 221D from the photographic equipment 210 through the dedicated line. The encoder apparatuses 221A to 221D may thereby each receive the 4K partial images to be processed thereby. Description will be given with reference to FIG. 7.

FIG. 7 is an explanatory diagram of another example where the image processing apparatus 100 receives an input of the original image P. In FIG. 7, the photographic equipment 210 photographs an 8K original image and produces 16 high definition video (FullHD) partial images A1 to D4 by dividing each of the n 8K original images P included in the 8K video image into four in the top-and-bottom direction and further into four in the right-and-left direction. For each of the 8K original images P, the photographic equipment 210 transmits the four FullHD partial images to be processed by any one of the encoder apparatuses 221A to 221D to the one of the encoder apparatuses 221A to 221D through any one the four dedicated lines. For example, in accordance with the transmission standard called 3G-SDI, the photographic equipment 210 transmits the 4K partial images A to D each to the encoder apparatuses 221A to 221D using coaxial cables connected to the encoder apparatuses 221A to 221D.

The encoder apparatus 221A receives the FullHD partial images A1 to A4 assigned thereto, from the photographic equipment 210 through four dedicated lines. The encoder apparatus 221A combines the received FullHD partial images A1 to A4 with each other to produce the 4K partial image A assigned thereto. The encoder apparatus 221B receives the FullHD partial images B1 to B4 assigned thereto, from the photographic equipment 210 through four dedicated lines. The encoder apparatus 221B combines the received FullHD partial images B1 to B4 with each other to produce the 4K partial image B assigned thereto.

The encoder apparatus 221C receives the FullHD partial images C1 to C4 assigned thereto, from the photographic equipment 210 through four dedicated lines. The encoder apparatus 221C combines the received FullHD partial images C1 to C4 with each other to produce the 4K partial image C assigned thereto. The encoder apparatus 221D receives the FullHD partial images D1 to D4 assigned thereto, from the photographic equipment 210 through four dedicated lines. The encoder apparatus 221D combines the received FullHD partial images D1 to D4 with each other to produce the 4K partial image D assigned thereto.

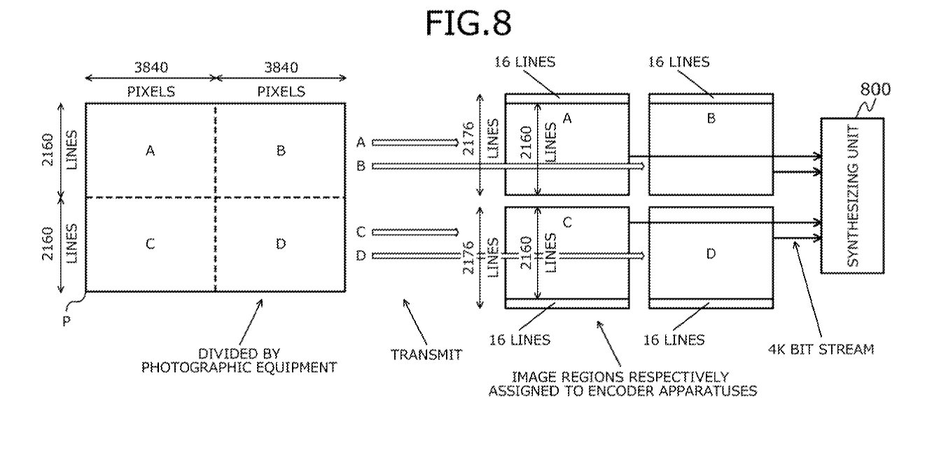

Each of the encoder apparatuses 221A to 221D may thereby produce the 4K partial image assigned thereto. Assuming that each of the encoder apparatuses 221A to 221D receives or produces the 4K partial image assigned thereto as in FIG. 6 or 7, the description will be given with reference to FIG. 8.

FIG. 8 is an explanatory diagram of an example where the image processing apparatus 100 executes the encoding process. In FIG. 8, the encoder apparatus 221A adds 16 dummy screen lines to the top portion of the 4K partial image A assigned thereto. The encoder apparatus 221A executes the encoding process for the partial image A acquired after the addition of the dummy screen lines thereto, using the 64×64 encoding process unit. The encoder apparatus 221A adds a syntax to encoded data eA acquired by executing the encoding process for the partial image A acquired after the addition of the dummy screen lines thereto. In this manner, the encoder apparatus 221A produces the encoded data eA for each of the original images P.

In the following description, when the encoded data eA is distinguished to clarify how many original images P are present before and including the original image P that is divided to produce the partial image A from which the encoded data eA is acquired, the encoded data eA may be written as “encoded data eA(i)”. The encoder apparatus 221A outputs pieces of encoded data eA(1) to eA(n) to a synthesizing unit 800 as a 4K bit stream sequentially from the encoded data eA(1).

The encoder apparatus 221B adds 16 dummy screen lines to the top portion of the 4K partial image B assigned thereto. The encoder apparatus 221B executes the encoding process for the partial image B acquired after the addition of the dummy screen lines thereto, using the 64×64 encoding process unit. The encoder apparatus 221B adds a syntax to encoded data eB acquired by executing the encoding process for the partial image B acquired after the addition of the dummy screen lines thereto. In this manner, the encoder apparatus 221B produces the encoded data eB for each of the original images P.

In the following description, when the encoded data eB is distinguished to clarify how many original images P are present before and including the original image P that is divided to produce the partial image B from which the encoded data eB is acquired, the encoded data eB may be written as “encoded data eB(i)”. The encoder apparatus 221B outputs pieces of encoded data eB(1) to eB(n) to a synthesizing unit 800 as a 4K bit stream sequentially from the encoded data eB(1).

The encoder apparatus 221C adds 16 dummy screen lines to the bottom portion of the 4K partial image C assigned thereto. The encoder apparatus 221C executes the encoding process for the partial image C acquired after the addition of the dummy screen lines thereto, using the 64×64 encoding process unit. The encoder apparatus 221C adds a syntax to encoded data eC acquired by executing the encoding process for the partial image C acquired after the addition of the dummy screen lines thereto. In this manner, the encoder apparatus 221C produces the encoded data eC for each of the original images P.

In the following description, when the encoded data eC is distinguished to clarify how many original images P are present before and including the original image P that is divided to produce the partial image B from which the encoded data eC is acquired, the encoded data eC may be written as “encoded data eC(i)”. The encoder apparatus 221C outputs pieces of encoded data eC(1) to eC(n) to a synthesizing unit 800 as a 4K bit stream sequentially from the encoded data eC(1).

The encoder apparatus 221D adds 16 dummy screen lines to the bottom portion of the 4K partial image D assigned thereto. The encoder apparatus 221D executes the encoding process for the partial image D acquired after the addition of the dummy screen lines thereto, using the 64×64 encoding process unit. The encoder apparatus 221D adds a syntax to encoded data eD acquired by executing the encoding process for the partial image D acquired after the addition of the dummy screen lines thereto. In this manner, the encoder apparatus 221D produces the encoded data eD for each of the original images P.

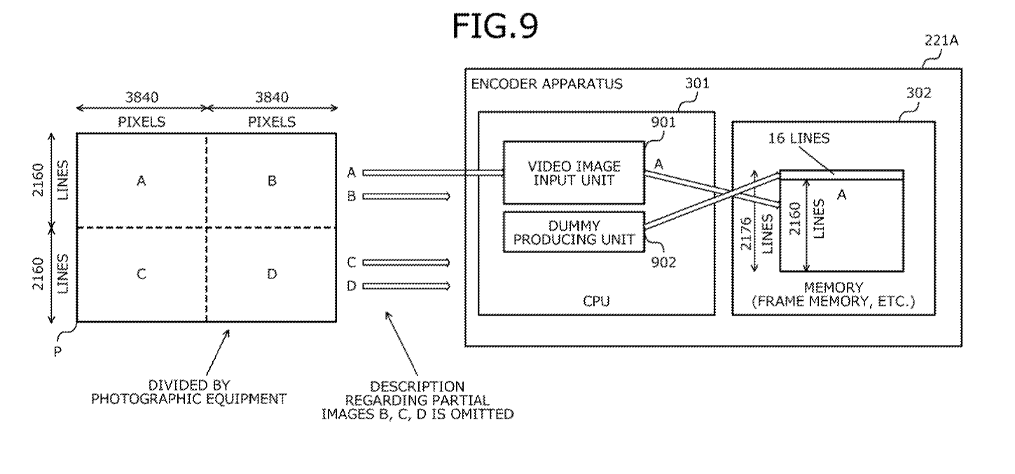

In the following description, when the encoded data eD is distinguished to clarify how many original images P are present before and including the original image P that is divided to produce the partial image D from which the encoded data eD is acquired, the encoded data eD may be written as “encoded data eD(i)”. The encoder apparatus 221D outputs pieces of encoded data eD(1) to eD(n) to the synthesizing unit 800 as a 4K bit stream sequentially from the encoded data eD(1). The description will be given with reference to FIG. 9 to describe the details for the encoder apparatus 221 to add the dummy screen lines.

FIG. 9 is an explanatory diagram of the details for the encoder apparatus 221 to add the dummy screen lines. In the example of FIG. 9, for simplicity of the description, the description will be made taking an example of the encoder apparatus 221A. The encoder apparatuses 221B, 221C, and 221D are each the same as the encoder apparatus 221A and will not again be described in detail. In FIG. 9, the encoder apparatus 221A includes a video image input unit 901 and a dummy producing unit 902.

The video image input unit 901 receives from the photographic equipment 210, the 4K partial image A assigned to the encoder apparatus 221A, of the four 4K partial images acquired by dividing the 8K original image P included in the 8K video image, into two in the top-and-bottom direction and further dividing into two in the right-and-left direction. The video image input unit 901 stores the 4K partial image A to, of the storage area prepared in the memory 302 for storing the 3,840×2,176 partial image to be the target of the encoding process, a remaining storage area except the storage area starting from the head and having the dummy screen lines stored therein. The video image input unit 901 may thereby receive the input of the partial image to be the target of the encoding process.

The video image input unit 901 of the encoder apparatus 221B is the same as the video image input unit 901 of the encoder apparatus 221A. For example, the video image input unit 901 of the encoder apparatus 221C stores the 4K partial image C to the storage area from the head thereof, prepared in the memory 302 for storing the 3,840×2,176 partial image to be the target of the encoding process. The video image input unit 901 of the encoder apparatus 221D is the same as the video image input unit 901 of the encoder apparatus 221C.

The dummy producing unit 902 adds the dummy screen lines to the partial image A assigned to the encoder apparatus 221A. For example, the dummy producing unit 902 stores the 16 dummy screen lines to, of the storage area of the memory 302 for storing the 3,840×2,176 partial image to be the target of the encoding process, the storage area starting from the head and having the dummy screen lines stored therein.

At this time, the dummy producing unit 902 may use, for example, lines each formed by lining pixels representing a black color, as the dummy screen lines. The dummy producing unit 902 may use, for example, lines each formed by lining pixels representing a color other than the black color, as the dummy screen lines. The dummy producing unit 902 may store the dummy screen lines before the video image input unit 901 stores the partial images.

The dummy producing unit 902 may further include a circuit that masks the data read from the memory 302. When the dummy producing unit 902 reads the partial image to be the target of the encoding process from the memory 302, the dummy producing unit 902 may replace the portion that corresponds to the dummy screen lines of the partial image to be the target of the encoding process, with the pixels representing the black color.

The dummy producing unit 902 may further include a circuit that changes the read destination from the memory 302. In a case where the dummy producing unit 902 reads the partial image to be the target of the encoding process from the memory 302, the dummy producing unit 902 may read the effective screen lines adjacent to the dummy screen lines when the dummy producing unit 902 reads the dummy screen lines of the partial image to be the target of the encoding process. The dummy producing unit 902 may thereby produce the 3,840×2,176 partial image for this partial image to be divisible by the 32×32 encoding process unit or the 64×46 encoding process unit, and may efficiently execute the encoding process.

The dummy producing unit 902 of the encoder apparatus 221B is the same as the dummy producing unit 902 of the encoder apparatus 221A. For example, the dummy producing unit 902 of the encoder apparatus 221C stores the 16 dummy screen lines to, of the storage area of the memory 302 for storing the 3,840×2,176 partial image to be the target of the encoding process, a storage area at the tail and having the dummy screen lines stored therein. The dummy producing unit 902 of the encoder apparatus 221D is the same as the dummy producing unit 902 of the encoder apparatus 221C.

The encoder apparatus 221A executes the encoding process for the partial image assigned to the encoder apparatus 221A acquired after the addition of the dummy screen lines thereto. For the dummy screen lines, the encoder apparatus 221A may execute a special process such as execution of an encoding process to suppress the data amount because the image quality may be degraded.

For example, the encoder apparatus 221A designates a storage area prepared in the memory 302 for storing the 3,840×2,176 partial image to be the target of the encoding process, and instructs the encoding process to the encoder block 304. The encoder apparatus 221A may thereby efficiently execute the encoding process.

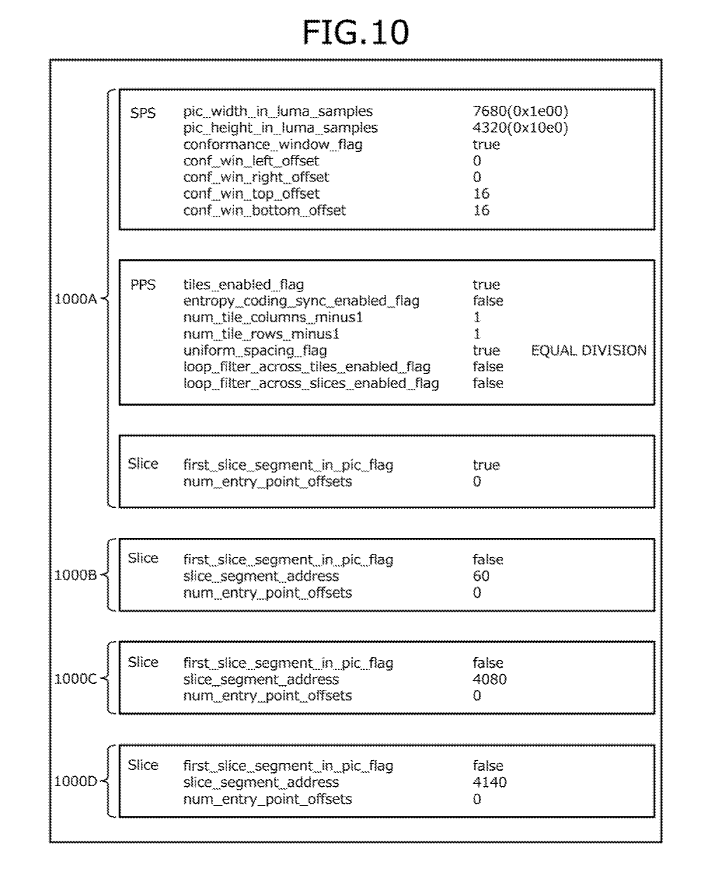

In this manner, the image processing apparatus 100 realizes a function of the input unit 501 by, for example, the video image input units 901 included in the encoder apparatuses 221A to 221D. The image processing apparatus 100 realizes a function of the adding unit 502 by, for example, the video image input units 901 and the dummy producing units 902 included in the encoder apparatuses 221A to 221D. Description will be given with reference to FIG. 10 to describe the details of the addition of a syntax 1000.

FIG. 10 is an explanatory diagram of the details of the addition of the syntax 1000 by the image processing apparatus 100. The syntax 1000 is information that is used when the decoding process is executed or when a video image is displayed and that is defined in accordance with the HEVC standard.

The encoder apparatuses 221A to 221D each adds the syntax 1000 to the encoded data taking into consideration the combining of the pieces of encoded data with each other by the synthesizing unit 800. The encoder apparatuses 221A to 221D may each add the syntax 1000 to the encoded data without taking into consideration the combining of the pieces of encoded data with each other by the synthesizing unit 800, and may rewrite the syntax 1000 when the synthesizing unit 800 combines the pieces of encoded data with each other.

The syntax 1000 includes a video parameter set (VPS), a sequence parameter set (SPS), a picture parameter set (PPS), and a slice. The VPS and the SPS are each information on the overall video image. The PPS is information that is related to each one of the original images P and that is related to the manner of dividing the original image P. The slice is information on the position of the partial image in the original image P.

In FIG. 10, the encoder apparatus 221A adds the syntax 1000 to the encoded data eA acquired by executing the encoding process for the partial image A assigned thereto. For example, because the partial image A assigned thereto is at the head and is combined as the head of the partial images A to D, the encoder apparatus 221A adds a syntax 1000A that includes the VPS, the SPS, and the PPS corresponding to the 8K original image P. The VPS will not be described.

The SPS of the syntax 1000A represents that the original image P is an 8K (7,680×4,320) image and represents that, after the decoding process, the original image P may be acquired by removing the 16 dummy screen lines in the top portion and the 16 dummy screen lines in the bottom portion.

For example, “pic_width_in_luma_samples=7680 (0×1e00)” and “pic_height_in_luma_samples=4320 (0×10e0)” each represents the size of the original image P.

“conformance_window_flag-true” represents that a portion to be removed is present when the decoding process is executed. “conf_win_left_offset=0” and “conf_win_right_offset=0” represent that no screen sequence to be removed is present on the right and the left sides.

“conf_win_top_offset=16” represents that 16 screen lines to be removed are present in the top portion, and represents that the 16 lines in the top portion are removed after the decoding process is executed. “conf_win_bottom_offset=16” represents that 16 screen lines to be removed are present in the bottom portion, and represents that the 16 lines in the bottom portion are removed after the decoding process is executed.

The decoding processing apparatus 230 may thereby recognize an 8K (7,680×4,320) image on the inner side acquired by removing the 16 dummy screen lines at each of the top and the bottom, from the 7,680×4,352 image acquired by executing the decoding process, as the original image P.

The PPS of the syntax 1000A represents that the original image P is divided into two in the top-and-bottom direction and further into two in the right-and-left direction. For example, “tiles_enabled_flagtrue” represents that the tile division is executed.

“entropy_coding_syncenabled_flag=false” will not be described. “num_tile_columns_minus1=1” represents how many dividing sessions are executed in the horizontal direction. “num_tile_rows_minus1=1” represents how many dividing sessions are executed in the vertical direction.

“uniform_spacing_flag=true” represents whether the equal division is executed. “loop_filter_across_tiles_enabled_flag=false” represents whether a loop filter is used for the border between the partial images, and the like. “loop_filter_across_slices_enabled_flag=false” represents whether a loop filter is used for the border between the partial images, and the like.

“Slice” of the syntax 1000A represents the position of the partial image A in the original image P. For example, “firstslice_segment_in_pic_fag=true” represents that the partial image A is present at the head of the original image P. “numentry_point_offsets=0” represents the upper-left position of the partial image A in the original image P using the number of the 64×64 encoding process units.

The encoder apparatus 221B adds a syntax 1000B to the encoded data eB acquired by executing the encoding process for the partial image B assigned thereto. The syntax 1000B may omit the VPS, the SPS, and the PPS.

“Slice” of the syntax 1000B represents the position of the partial image B in the original image P. For example, “first_slice_segment_in_pic_flBg=false” represents that the partial image B is present at the head of the original image P. “num_entry_point_offsets=60” represents the upper-left position of the partial image B of the original image P using the number of the 64×64 encoding process units. “num_entry_point_offsets=0” will not be described.

The encoder apparatus 221C adds a syntax 1000C to the encoded data eC acquired by executing the encoding process for the partial image C assigned thereto. The syntax 1000C may omit the VPS, the SPS, and the PPS.

“Slice” of the syntax 1000C represents the position of the partial image C in the original image P. For example, “first_slice_segment in_pic_flCg=false” represents that the partial image C is present at the head of the original image P. “num_entry_pointoffsets=4080” represents the upper-left position of the partial image C in the original image P using the number of the 64×64 encoding process units. “num_entry_point_offsets=0” will not be described.

The encoder apparatus 221D adds a syntax 1000D to the encoded data eD acquired by executing the encoding process for the partial image D assigned thereto. The syntax 1000D may omit the VPS, the SPS, and the PPS.

“Slice” of the syntax 1000D represents the position of the partial image D in the original image P. For example, “first_slice_segment_in_pic_flDg=false” represents that the partial image D is present at the head of the original image P. “num_entry_point_offsets=4140” represents the upper-left position of the partial image D of the original image P using the number of the 64×64 encoding process units. “num_entry_pointoffsets=0” will not be described.

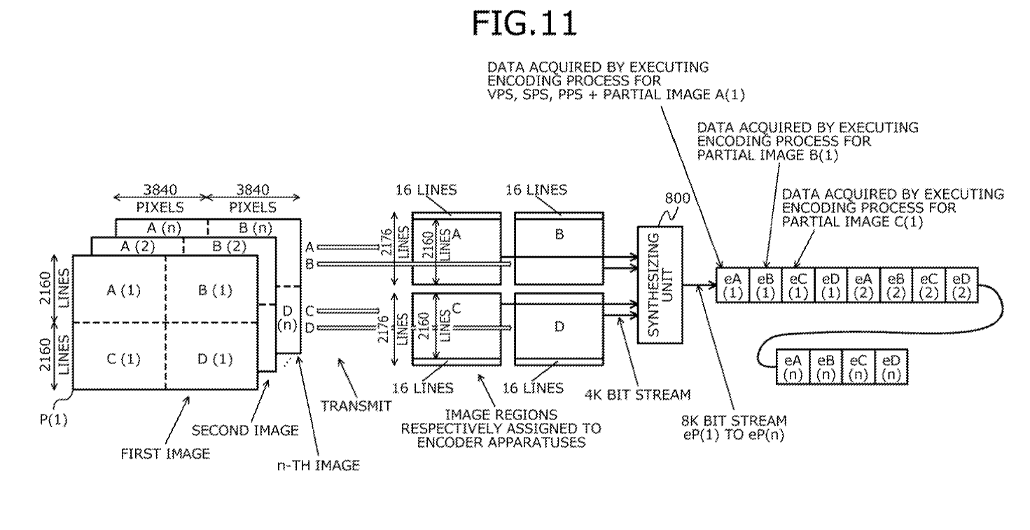

The image processing apparatus 100 enables the decoding processing apparatus 230 to learn the 16 dummy screen lines in the top portion and the 16 dummy screen lines in the bottom portion to be removed to acquire the original image P after executing the decoding process. Description will be given with reference to FIG. 11.

FIG. 11 is an explanatory diagram of an example where the image processing apparatus 100 synthesizes the pieces of encoded data with each other. In FIG. 11, the image processing apparatus 100 includes the synthesizing unit 800. The synthesizing unit 800 sequentially combines the pieces of encoded data eA(1), eB(1), eC(1), and eD(1) respectively corresponding to the partial images A(1), B(1), C(1), and D(1) that are acquired based on the first original image P(1). The synthesizing unit 800 thereby produces combined data eP(1) that corresponds to the result of the execution of the encoding process for the first original image P(1). For the second and the later original images P(2) to P(n), the synthesizing unit 800 similarly produces pieces of combined data eP(2) to eP(n) that correspond to the results of the execution sessions of the encoding process for the second and the subsequent original images P(2) to P(n).

The synthesizing unit 800 outputs the pieces of combined data eP(1) to eP(n) that correspond to the results of the execution sessions of the encoding process for the original images P(1) to P(n) sequentially from the combined data eP(1) that corresponds to the result of the execution of the encoding process for the first original image P(1), as 8K bit streams. The synthesizing unit 800 may thereby output the 8K bit streams that correspond to the 8K video image.

For simplicity of the description, while the description has been given for the order of the original images P and the order of the 8K bit streams to match with each other, the order is not limited hereto. For example, when a reordering approach of the HEVC standard is used, the order of the original images P and the order of the 8K bit streams may be different from each other.

The image processing apparatus 100 may thereby transmit the 8K bit streams that correspond to the 8K video image to the decoding processing apparatus 230 to be displayed. The decoding processing apparatus 230 may decode the four 4K images for each of the 8K images based on the 8K bit streams that correspond to the received 8K video image.

The decoding processing apparatus 230 may omit a reconstituting circuit that reconstitutes the four 4K partial images from the four 7,680×1,088 partial images. The decoding processing apparatus 230 may display the 8K image based on the decoded four 4K images, and may efficiently display the 8K image. In this manner, for example, the image processing apparatus 100 realizes the function of the combining unit 504 using the synthesizing unit 800.

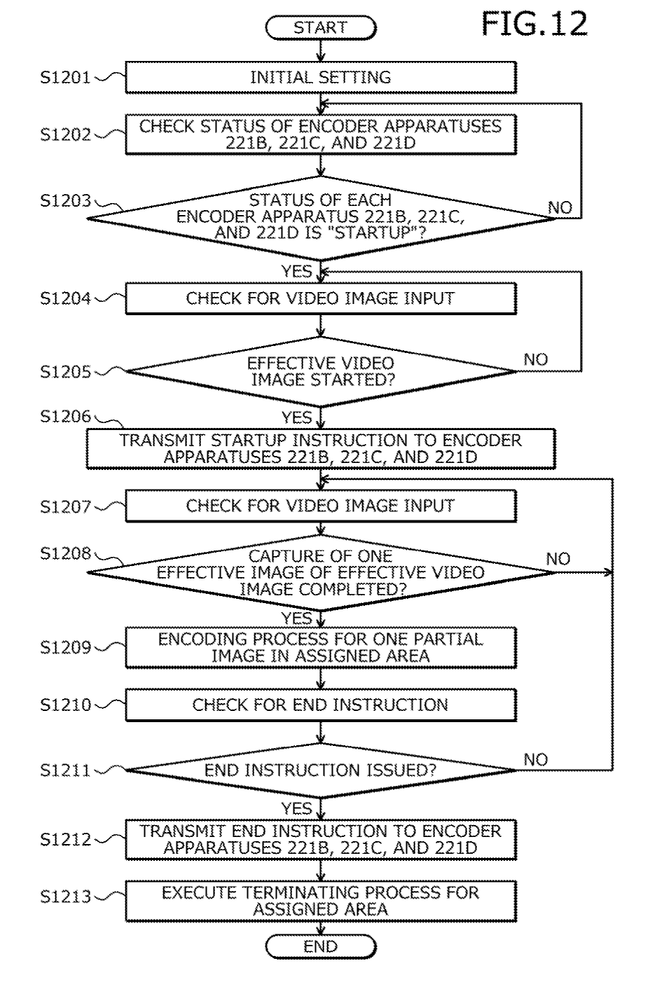

An example of a procedure for the encoding process for the partial image at the head executed by the encoder apparatus 221 will be described with reference to FIG. 12.

FIG. 12 is a flowchart of an example of the procedure for the encoding process for the partial image at the head. In FIG. 12, the encoder apparatus 221A makes an initial setting (step S1201). For example, as the initial setting, the encoder apparatus 221A prepares, in the memory 302, a storage area to store therein the 3,840×2,176 partial image to be the target of the encoding process.

As the initial setting, the encoder apparatus 221A stores the dummy screen lines from the head of the prepared storage area and, for the partial image in the assigned area of the images input as the video image not to be overwritten on the dummy screen lines but to be sequentially written continuously thereafter, sets the position to write the partial image. The initial setting may include clearing of variables used in various types of processes, clearing of the setting concerning hardware and software, and the like.

The encoder apparatus 221A checks the status of each of the encoder apparatuses 221B, 221C, and 221D (step S1202). The encoder apparatus 221A determines whether the status of each of the encoder apparatuses 221B, 221C, and 221D is “startup” (step S1203). When the encoder apparatus 221A determines that the status of any one of the encoder apparatuses 221B, 221C, and 221D is not “startup” (step S1203: NO), the encoder apparatus 221A returns to the operation at step S1202.

On the other hand, when the encoder apparatus 221A determines that the status of each of the encoder apparatuses 221B, 221C, and 221D is startup (step S1203: YES), the encoder apparatus 221A checks for video image input (step S1204). The encoder apparatus 221A determines whether an effective video image is started (step S1205). When the encoder apparatus 221A determines that no effective video image is started (step S1205: NO), the encoder apparatus 221A returns to the operation at step S1204.

On the other hand, when the encoder apparatus 221A determines that an effective video image is started (step S1205: YES), the encoder apparatus 221A transmits a startup instruction to the encoder apparatuses 221B. 221C, and 221D (step S1206). The encoder apparatus 221A checks for video image input (step S1207). The encoder apparatus 221A determines whether capture of one effective image of the effective video image is completed (step 31208). When the encoder apparatus 221A determines that the capture is not completed (step S1208: NO), the encoder apparatus 221A returns to the operation at step S1207.

On the other hand, when the encoder apparatus 221A determines that the capture is completed (step S1208: YES), the encoder apparatus 221A executes the encoding process for one partial image in the assigned area (step S1209). At this step, the encoder apparatus 221A may add a syntax to the partial image for which the encoding process is executed.

The encoder apparatus 221A checks for an end instruction from the main body unit 222 (step S1210). The encoder apparatus 221A determines whether the end instruction is issued (step S1211). When the encoder apparatus 221A determines that the end instruction is not issued (step S1211: NO), the encoder apparatus 211A returns to the operation at step S1207.

On the other hand, when the encoder apparatus 221A determines that the end instruction is issued (step S1211: YES), the encoder apparatus 211A transmits the end instruction to the encoder apparatuses 221B, 221C, and 221D (step S1212). The encoder apparatus 221A executes a terminating process for the assigned area (step S1213). Even in the case where the end instruction is issued, when the data to be processed still remains, the encoder apparatus 221A processes this data as the terminating process. For example, the encoder apparatus 221A executes a post-process associated with the reordering and the like.

The encoder apparatus 221A causes the encoding process for the partial image at the head to come to an end. The encoder apparatus 221A may thereby add the dummy screen lines to the partial image assigned thereto and may efficiently execute the encoding process for the partial image assigned thereto. The encoder apparatus 221A may execute the above operations in parallel to each other using pipelines.

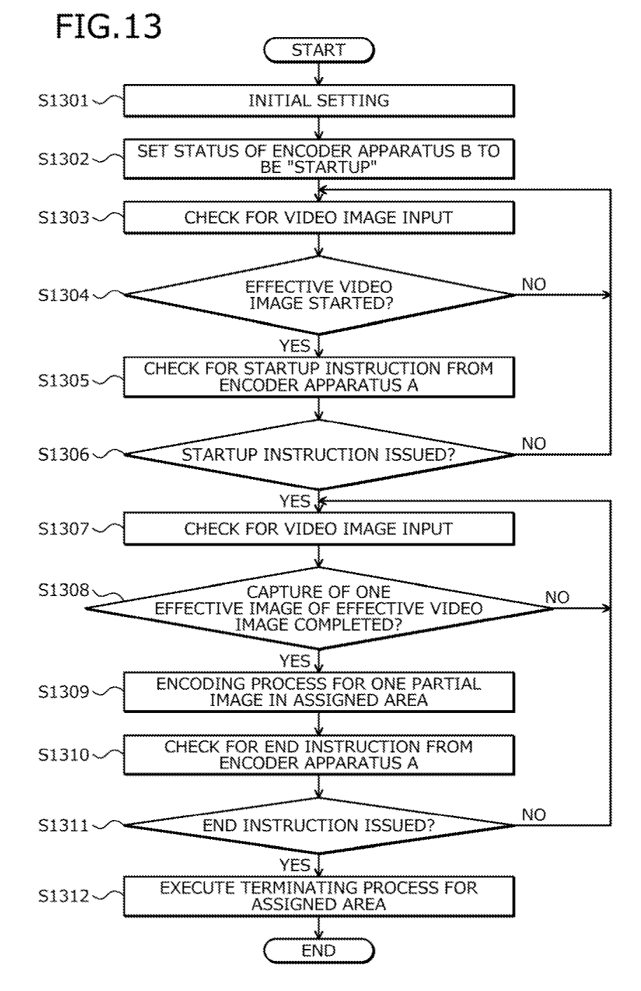

An example of a procedure for the encoding process for the partial image other than that at the head executed by the encoder apparatus 221A will be described with reference to FIG. 13.

FIG. 13 is a flowchart of an example of the procedure for the encoding process for the partial image other than that at the head. In FIG. 13, the encoder apparatus 221B makes an initial setting (step S1301). For example, as the initial setting, the encoder apparatus 221B prepares in the memory 302, the storage area to store therein the 3,840×2,176 partial image to be the target of the encoding process.

As the initial setting, the encoder apparatus 221B stores the dummy screen lines from the head of the prepared storage area and for the partial image to the assigned area of the images input as the video image not to be overwritten on the dummy screen lines but to be sequentially written continuously thereafter, sets the position to write the partial image. The initial setting may include the clearing of variables used in various types of process, the clearing of the setting concerning hardware and software, and the like.

The encoder apparatus 221B sets the status of the encoder apparatus 221B to be “startup” (step S1302). The encoder apparatus 221B checks for video image input (step S1303). The encoder apparatus 221B determines whether an effective video image is started (step S1304). When the encoder apparatus 221B determines that no effective video image is started (step S1304: NO), the encoder apparatus 221B returns to the operation at step S1303.

On the other hand, when the encoder apparatus 221B determines that an effective video image is started (step S1304: YES), the encoder apparatus 221B checks for a startup instruction from the encoder apparatus 221A (step S1305). The encoder apparatus 221B determines whether a startup instruction is issued (step S1306). When the encoder apparatus 221B determines that no startup instruction is issued (step S1306: NO), the encoder apparatus 221B returns to the operation at step S1303.

On the other hand, when the encoder apparatus 221B determines that a startup instruction is issued (step S1306: YES), the encoder apparatus 221B checks for video image input (step S1307). The encoder apparatus 221B determines whether capture of one effective image of the effective video image is completed (step S1308). When the encoder apparatus 221B determines that the capture is not completed (step S1308: NO), the encoder apparatus 221B returns to the operation at step S1307.

On the other hand, when the encoder apparatus 221B determines that the capture is completed (step S1308: YES), the encoder apparatus 221B executes the encoding process for one partial image in the assigned area (step 1309). At this step, the encoder apparatus 221A may add a syntax to the partial image for which the encoding process is executed.

The encoder apparatus 221B checks for an end instruction from the encoder apparatus 221A (step S1310). The encoder apparatus 221B determines whether the end instruction is issued (step S1311). When the encoder apparatus 221B determines that the end instruction is not issued (step S1311: NO), the encoder apparatus 211B returns to the operation at step S1307.

On the other hand, when the encoder apparatus 221B determines that the end instruction is issued (step S1311: YES), the encoder apparatus 211B executes the terminating process for the assigned area (step S1312). Even in a case where the end instruction is issued, when the data to be processed still remains, the encoder apparatus 221B processes this data as the terminating process. For example, the encoder apparatus 221B executes a post-process associated with the reordering and the like.

The encoder apparatus 221B causes the encoding process for the partial image other than that at the head to come to an end. The processes by the encoder apparatuses 221C and 221D are each the same as the process by the encoder apparatus 221B and will not again be described except the initial setting thereof.

As the initial setting, the encoder apparatuses 221C and 221D each stores the dummy screen lines at the tail of the prepared storage area and, for the partial image in the assigned area of the images input as the video image to be written into the prepared storage area from the head thereof, each sets a position to write the partial image.

Thus, the encoder apparatuses 221B, 221C, and 221D each may add the dummy screen lines to the partial image assigned thereto and each may efficiently execute the encoding process for the partial image assigned thereto. The encoder apparatuses 221B, 221C, and 221D may each execute the above processes in parallel to each other using pipelines.

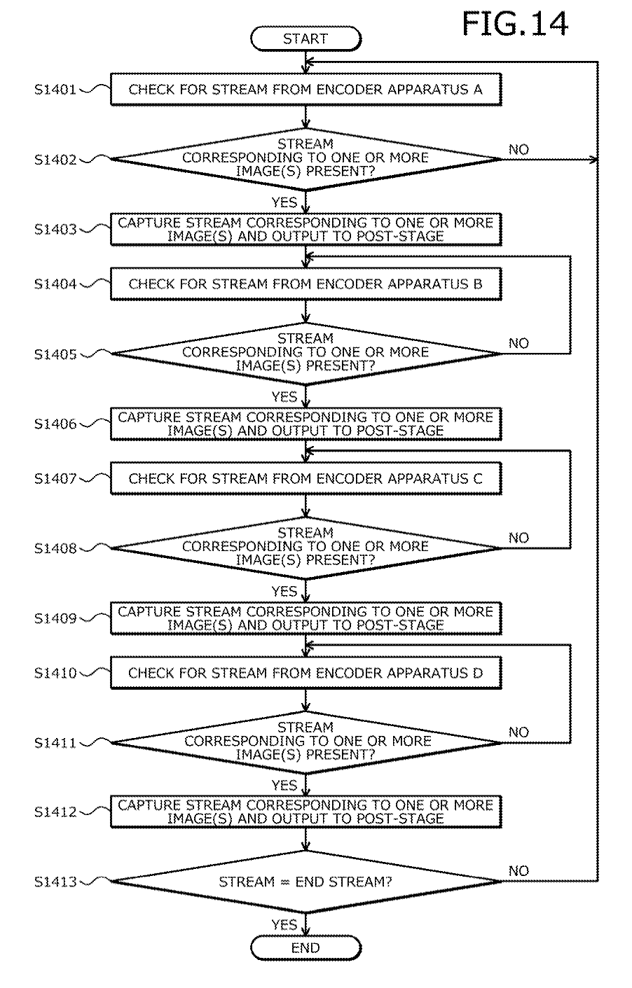

An example of a procedure for a combining process executed by the main body unit 222 will be described with reference to FIG. 14.

FIG. 14 is a flowchart of an example of the procedure for the combining process. In FIG. 14, the main body unit 222 checks for a stream from the encoder apparatus 221A (step S1401). The main body unit 222 checks whether a stream corresponding to one or more image(s) is present (step S1402).

When the main body unit 222 determines that no stream corresponding to one or more image(s) is present (step S1402: NO), the main body unit 222 returns to the operation at step S1401. On the other hand, when the main body unit 222 determines that a stream corresponding to one or more image(s) is present (step S1402: YES), the main body unit 222 captures the stream corresponding to one or more image(s) and outputs the stream to the post-stage (step S1403). The “post-stage” is, for example, the memory 402. The post-stage may be, for example, the disk drive or the network 240 connected through the network I/F 403.

The main body unit 222 checks for a stream from the encoder apparatus 221B (step S1404). The main body unit 222 determines whether a stream corresponding to one or more image(s) is present (step S1405).

When the main body unit 222 determines that no stream corresponding to one or more image(s) is present (step S1405: NO), the main body unit 222 returns to the operation at step S1404. On the other hand, when the main body unit 222 determines that a stream corresponding to one or more image(s) is present (step S1405: YES), the main body unit 222 captures the stream corresponding to one or more image(s) and outputs the stream to the post-stage (step S1406).

The main body unit 222 checks for a stream from the encoder apparatus 221C (step S1407). The main body unit 222 determines whether a stream corresponding to one or more image(s) is present (step S1408).

When the main body unit 222 determines that no stream corresponding to one or more image(s) is present (step S1408: NO), the main body unit 222 returns to the operation at step S1407. On the other hand, when the main body unit 222 determines that a stream corresponding to one or more image(s) is present (step S1408: YES), the main body unit 222 captures the stream corresponding to one or more image(s) and outputs the stream to the post-stage (step S1409).

The main body unit 222 checks for a stream from the encoder apparatus 221D (step S1410). The main body unit 222 determines whether a stream corresponding to one or more image(s) is present (step S1411).

When the main body unit 222 determines that no stream corresponding to one or more image(s) is present (step S1411: NO), the main body unit 222 returns to the operation at step S1410. On the other hand, when the main body unit 222 determines that a stream corresponding to one or more image(s) is present (step S1411: YES), the main body unit 222 captures the stream corresponding to one or more image(s) and outputs the stream to the post-stage (step S1412).

The main body unit 222 determines whether the stream is an end stream (step S1413). When the main body unit 222 determines that the stream is not an end stream (step S1413: NO), the main body unit 222 returns to the operation at step S1401. On the other hand, when the main body unit 222 determines that the stream is an end stream (step S1413: YES), the main body unit 222 causes the combining process to come to an end.

The main body unit 222 may thereby combine the original images for which the encoding process is executed, according to their order and may have the original images stored therein as a video image for which the encoding process is executed. The main body unit 222 may execute the above operations in parallel to each other using pipelines.

As described, according to the image processing apparatus 100, the input of the original image 110 divided into at least two in the top-and-bottom direction may be received. According to the image processing apparatus 100, the first line number of dummy screen lines 131 may be added to the top portion of the top portion partial image 111 of the original image 110 whose input is received. According to the image processing apparatus 100, the second line number of dummy screen lines 132 may be added to the bottom portion of the bottom portion partial image 112 of the original image 110 whose input is received. According to the image processing apparatus 100, the encoding process may be executed for each of the partial images each having the dummy screen lines added thereto using the encoding process unit 120. The image processing apparatus 100 may thereby efficiently execute the encoding process.

According to the image processing apparatus 100, the input of the original image 110 divided into two in the top-and-bottom direction and further into two in the right-and-left direction may be received. The image processing apparatus 100 may thereby execute the encoding process for each of the partial images acquired by equally dividing the original image 110 into four.

According to the image processing apparatus 100, the partial images for which the encoding process is executed may be combined with each other according to the predetermined order and the original image 110 for which the encoding process is executed may thereby be produced. The image processing apparatus 100 may thereby store therein have the original image 110 for which the encoding process is executed.

According to the image processing apparatus 100, the first line number and the second line number may be output being correlated with the original image 110 for which the encoding process is executed. The image processing apparatus 100 may thereby enable the first line number of the dummy screen lines to be removed from the top portion and the second line number of the dummy screen lines to be removed from the bottom portion to be learned, after executing the decoding process for the original image 110 for which the encoding process is executed.

According to the image processing apparatus 100, an input of the plural original images 110 included in a video image may be received. According to the image processing apparatus 100, the original images 110 for which the encoding process is executed may be combined with each other according to the display order of the original images 110 in the video image. The image processing apparatus 100 may thereby store therein the video image for which the encoding process is executed.

According to the image processing apparatus 100, the original image 110 whose number of the effective screen lines is 2,160 may be used. According to the image processing apparatus 100, the encoding process unit 120 whose number of the screen lines is 32 or 64 may be used. According to the image processing apparatus 100, 16 dummy screen lines may be added to the top portion of the top portion partial image 111 of the original image 110 whose input is received. According to the image processing apparatus 100, 16 dummy screen lines may be added to the bottom portion of the bottom portion partial image 112 of the original image 110 whose input is received. The image processing apparatus 100 may thereby execute the encoding process for the 8K original image 110.

The image processing method described in this embodiment may be realized by causing a computer such as a personal computer or a work station to execute programs prepared in advance. The encoder apparatus 221 may be a 4K-processing LSI. The program according to this image processing is recorded to a non-transitory, computer-readable recording medium such as a hard disk, a flexible disk, a CD-ROM, an MO, or a DVD, and is executed by being read by the computer from the recording medium. The program according to this image processing may be distributed through a network such as the Internet.

According to one aspect of the present invention, an effect is achieved in that the encoding process may be efficiently executed.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An image processing apparatus comprising:
a memory; and
a processor coupled to the memory, the processor configured to:
receive an input of an original image divided into at least two partial images in a top-and-bottom direction;
for a top portion partial image of the original image whose input is received, add to a top portion of the top portion partial image, dummy screen lines of a first line number that is a difference of a number of effective screen lines included in the top portion partial image and an integral multiple of screen lines included in one encoding process unit of an encoding process, the integral multiple being greater than the number of effective screen lines included in the top portion partial image;
for a bottom portion partial image of the original image whose input is received, add to a bottom portion of the bottom portion partial image, the dummy screen lines of a second line number that is a difference of the number of effective screen lines included in the bottom portion partial image and the integral multiple of screen lines included in the encoding process unit, the integral multiple being greater than the number of effective screen lines included in the bottom portion partial image; and
for each of the partial images to which the dummy screen lines are added, execute the encoding process by using the encoding process unit.

2. The image processing apparatus according to claim 1, wherein
the processor receives the input of the original image divided into two partial images in the top-and-bottom direction and further divided into two partial images in a right-and-left direction.

3. The image processing apparatus according to claim 1, wherein
the processor combines according to a predetermined order, the partial images for which the encoding process is executed, and produces the original image for which the encoding process is executed.

4. The image processing apparatus according to claim 3, wherein
the processor outputs the first line number and the second line number, correlating the first line number and the second line number with the original image for which the encoding process is executed.

5. The image processing apparatus according to claim 3, wherein
the processor receives an input of plural original images included in a video image, and
combines according to a display order of the plural original images in the video image, the plural original images for which the encoding process is executed.

6. The image processing apparatus according to claim 1, wherein
the number of the effective screen lines is 2,160,
the number of the screen lines is 32 or 64, and
the processor, for the top portion partial image of the original image whose input is received, adds the 16 dummy screen lines to the top portion of the top portion partial image and
for the bottom portion partial image of the original image whose input is received, adds the 16 dummy screen lines to the bottom portion of the bottom portion partial image.

7. An image processing method executed by a computer, the image processing method comprising:
receiving an input of an original image divided into at least two partial images in a top-and-bottom direction;
for a top portion partial image of the original image whose input is received, adding to a top portion of the top portion partial image, dummy screen lines of a first line number that is a difference of a number of effective screen lines included in the top portion partial image and an integral multiple of screen lines included in one encoding process unit of an encoding process, the integral multiple being greater than the number of effective screen lines included in the top portion partial image;
for a bottom portion partial image of the original image whose input is received, adding to a bottom portion of the bottom portion partial image, the dummy screen lines of a second line number that is a difference of the number of effective screen lines included in the bottom portion partial image and the integral multiple of screen lines included in the encoding process unit, the integral multiple being greater than the number of effective screen lines included in the bottom portion partial image; and
for each of the partial images to which the dummy screen lines are added, executing the encoding process by using the encoding process unit.
